(19) United States
(12) Patent Application Publication
(10) Pub. No.: US 2026/0120959 A1
(43) Pub. Date: Apr. 30, 2026

(54) ELECTRETS FOR POWER ELECTRONIC APPLICATIONS

(71) Applicant: UWM Research Foundation, Inc., Milwaukee, WI (US)

(72) Inventor: Chanyeop Park, Milwaukee, WI (US)

(21) Appl. No.: 18/789,151

(22) Filed: Jul. 30, 2024

Related U.S. Application Data
(60) Provisional application No. 63/516,895, filed on Aug. 1, 2023.
(60) Provisional application No. 63/621,321, filed on Jan. 16, 2024.

(51) Int. Cl. H01G 7/02

(52) U.S. Cl. CPC H01G 7/028; H01G 7/023; H01G 7/026

(57) ABSTRACT

Described herein are electrets and electrical components comprising electrets. Electrical components comprising electrets described herein may be incorporated into power substrates, power electronic modules, and laminated busbars.

### CROSS-REFERENCE TO RELATED APPLICATIONS

This application claims priority to U.S. Provisional Patent Application 63/516,895, filed on Aug. 1, 2023, the entire contents of which are incorporated herein by reference. This application also claims priority to U.S. Provisional Patent Application 63/621,321, filed on Jan. 16, 2024.

### STATEMENT OF GOVERNMENT INTEREST

This invention was made with government support under N00014-23-1-2673 and N00014-21-1-2797 awarded by the Office of Naval Research (ONR) of the United States Department of the Navy. The government has certain rights in the invention.

### TECHNICAL FIELD

The present disclosure relates to materials, methods, and techniques for electrets. Example electrets may be incorporated into various electrical components to address high-electric-field-related challenges. Example electrical components may be incorporated into power substrates, power electronic modules, and laminated busbars.

### SUMMARY

Power electronics is at the heart of the global energy transition, including transportation electrification, renewable energy integration, and hydrogen economy. However, decarbonizing society through electrification requires high-voltage (HV) power electronic devices that can reliably operate at high temperatures. As power semiconductor technology continues to advance toward higher voltage levels and outpace packaging and electrical insulation materials, ensuring the dielectric integrity of power electronic devices and medium voltage (MV) distribution systems has become increasingly challenging. While the advances in voltage rating and switching speed of wide bandgap (WBG) power semiconductors provide numerous benefits, including high power density, high efficiency, and the dynamic control of energy, such advancements also accelerate electrical aging and increase the risk of premature system failure. Studies have shown that recurring, steep voltage pulses induced by WBG devices operating at high temperatures render existing dielectric materials and insulation coordination approaches ineffective, promote more significant and more frequent partial discharge (PD), and degrade electrical insulators at a higher pace. An electric field at the triple point may be less than 100 V.

In one aspect, an electrical component is disclosed. The electrical component may comprise: a top conductive layer; a dielectric layer; a bottom conductive layer; an encapsulating material; and an electret interposed between a surface of the top conductive layer and a surface of the dielectric layer, the electret comprising: a silicon nitride (Si₃N₄) layer supported by a silicon dioxide (SiO₂) layer; or a Parylene layer; wherein the top conductive layer, the electret, and the encapsulating material intersect at a triple point (Tₚ). The top conductive layer, the dielectric layer, and the bottom conductive layer may be arranged in a stacked configuration. The encapsulating material may contact and surrounds the stacked configuration. The encapsulating material may contact and surround the stacked configuration. In some instances, the electret comprises the silicon nitride (Si₃N₄) layer supported by the silicon dioxide (SiO₂) layer. The silicon nitride (Si₃N₄) layer may have a thickness of 0.1 nm to 1 mm. The silicon dioxide (SiO₂) layer may have a thickness of 0.1 nm to 1 mm. In other instances, the electret comprises the Parylene layer. The Parylene layer may have a thickness of 0.1 nm to 1 mm. The electret may have a surface charge density of 0.1 mC/m² to 30 mC/m².

In some instances, a power substrate comprises the electrical component. In some instances, a power electronic module comprises the electrical component. In some instances, a laminated busbar comprises the electrical component. The method may comprise providing a substrate; depositing a thin film onto the substrate, the thin film comprising: a silicon nitride (Si₃N₄) layer supported by a silicon dioxide (SiO₂) layer; or a Parylene layer; and triode corona charging the thin film. The thin film may be deposited onto the substrate via sputtering and electron beam evaporation.

Before any embodiments, examples, aspects, and features of the disclosure are explained in detail, it is to be understood that the disclosure is not limited in its application to the details of construction and the arrangement of components set forth in the following description or illustrated in the following drawings. Other embodiments, examples, aspects, and features are possible and of being practiced or of being carried out in various ways.

### BRIEF DESCRIPTION OF THE DRAWINGS

FIG. 1 is a schematic illustrating a side view of an example electret.

FIG. 2 is a schematic illustrating a side view portion of an example electrical component comprising an example electret.

FIG. 3A is a schematic illustrating an example electronic circuit comprising an example electrical component.

FIG. 3B is a schematic illustrating the physical model variables used to quantify the required surface charge density of electrets that neutralizes the electric field at the triple point edge of example electrical component.

FIG. 3C is a schematic illustrating electric field neutralization at the triple point edge.

FIG. 4A is a schematic illustrating an example method of preparing SiO₂/Si₃N₄ electrets.

FIG. 4B is a photograph of the experimental setup used for preparing example SiO₂/Si₃N₄ electrets according to the schematic of FIG. 4A.

FIG. 5 is a schematic illustrating a side view of an example SiO₂/Si₃N₄ electret having a silicon nitride (Si₃N₄) layer thickness of 20 nm and a silicon dioxide (SiO₂) layer thickness of 1,000 nm.

FIG. 6 is a photograph of an example SiO₂/Si₃N₄ electret compared to a SiO₂/Si₃N₄ non-electret.

FIG. 7A is a schematic illustrating the experimental testbed used to measure partial discharge (PD) at high temperatures for the example SiO₂/Si₃N₄ electret.

FIG. 7B is a photograph of the experimental testbed used to measure partial discharge (PD) at high temperatures for the example SiO₂/Si₃N₄ electret.

FIGS. 8A-8D show how switching noise and partial discharge (PD) are separated from the current measured via a high frequency current transformer (HFCT) for the example SiO₂/Si₃N₄ electret.

FIG. 8A is a plot showing a cycle of a square voltage pulse.

FIG. 8B is a plot showing the total current measured by a high frequency current transformer (HFCT).

FIG. 8C is a plot showing switching noise induced by a steep rising edge of a square voltage pulse.

FIG. 8D is a plot showing partial discharge (PD) separated from the switching noise.

FIG. 9 shows the partial discharge (PD) of the SiO₂/Si₃N₄ non-electret and SiO₂/Si₃N₄ electret samples measured at 25° C., 175° C., and 245° C. under steep square voltage pulses.

FIG. 10 is a plot showing Weibull distribution of the partial discharge inception voltage (PDIV) of the SiO₂/Si₃N₄ non-electret and SiO₂/Si₃N₄ electret samples measured at 25° C., 175° C., and 245° C.

FIG. 11A is a schematic illustrating a side view of an example Parylene electret having a Parylene layer thickness of 9.62 μm.

FIG. 11B is a schematic illustrating an example method of preparing Parylene electrets.

FIG. 11C is a photograph of the experimental setup used for preparing example Parylene electrets according to the schematic of FIG. 11B.

FIG. 11D is a photograph of an example Parylene electret compared to a Parylene non-electret.

FIG. 12A is a schematic illustrating the experimental testbed used to measure partial discharge (PD) at high temperatures for the Parylene thin film tested without a Kapton sheet.

FIG. 12B is a photograph of the experimental testbed used to measure partial discharge (PD) at high temperatures for the Parylene thin film tested without a Kapton sheet.

FIG. 12C is a schematic illustrating the experimental testbed used to measure partial discharge (PD) at high temperatures for the Parylene thin film electret tested with a Kapton sheet.

FIG. 12D is a photograph of the experimental testbed used to measure partial discharge (PD) at high temperatures for the Parylene thin film electret tested with a Kapton sheet.

FIGS. 13A-13D show how switching noise and partial discharge (PD) are separated from the current measured via a high frequency current transformer (HFCT) for the example Parylene electret.

FIG. 13A is a plot showing a cycle of square voltage pulse.

FIG. 13B is a plot showing the total current measured by a high frequency current transformer (HFCT).

FIG. 13C is a plot showing switching noise induced by a steep rising edge of a square voltage.

FIG. 13D is a plot showing partial discharge (PD) separated from the switching noise.

FIG. 14 shows the partial discharge (PD) of the Parylene non-electret and Parylene electret samples measured at 25° C., 175° C., and 260° C. under steep square voltage pulses. The Parylene non-electret and Parylene electret samples were evaluated without a Kapton sheet.

FIG. 15 shows the partial discharge (PD) of the Parylene non-electret and Parylene electret samples measured at 25° C., 175° C., and 260° C. under steep square voltage pulses. The Parylene non-electret and Parylene electret samples were evaluated with a Kapton sheet.

FIG. 16A is a plot showing Weibull distribution of the partial discharge inception voltage (PDIV) of the Parylene non-electret and Parylene electret samples measured at 25° C., 175° C., and 260° C. The Parylene non-electret and Parylene electret samples were evaluated without a Kapton sheet.

FIG. 16B is a plot showing Weibull distribution of the partial discharge inception voltage (PDIV) of the Parylene non-electret and Parylene electret samples measured at 25° C., 175° C., and 260° C. The Parylene non-electret and Parylene electret samples were evaluated with a Kapton sheet.

FIG. 17A illustrates an example power substrate having a mesa configuration, the power substrate comprising a SiO₂/Si₃N₄ electret on an aluminum nitride (AlN)-based dielectric layer.

FIG. 17B illustrates a side view of example power substrate comprising a SiO₂/Si₃N₄ electret, a copper-based conductive layer, and an AlN-based dielectric layer, where active metal brazing adhering the conductive layer, SiO₂/Si₃N₄ electret, and dielectric layer together. The SiO₂/Si₃N₄ electret is interposed between the bottom edge surface of the copper-based conductive layer, and the top surface of the AlN-based dielectric layer.

FIG. 18A illustrates an example power substrate having a mesa configuration, the power substrate comprising a Parylene electret on an AlN-based dielectric layer.

FIG. 18B illustrates a side view of example power substrate comprising a Parylene electret, a copper-based conductive layer, and an AlN-based dielectric layer. The Parylene electret is interposed between the bottom edge surface of the copper-based conductive layer, and the top surface of the AlN-based dielectric layer.

### DETAILED DESCRIPTION

Example materials, methods, and techniques disclosed and contemplated herein generally relate to electrets and electrical components comprising the same. Example electrets and electrical components described herein may be particularly suited for use in power electronic applications, such as power substrates, high-voltage (HV) power modules, and laminated busbars.

### I. DEFINITIONS

Unless otherwise defined, all technical and scientific terms used herein have the same meaning as commonly understood by one of ordinary skill in the art. In case of conflict, the present document, including definitions, will control. Methods and materials are described below, although methods and materials similar or equivalent to those described herein can be used in practice or testing of the present disclosure. All publications, patent applications, patents and other references mentioned herein are incorporated by reference in their entirety. The materials, methods, and examples disclosed herein are illustrative only and not intended to be limiting.

The terms “comprise(s),” “include(s),” “having,” “has,” “can,” “contain(s),” and variants thereof, as used herein, are intended to be open-ended transitional phrases, terms, or words that do not preclude the possibility of additional acts or structures. The singular forms “a,” “an” and “the” include plural references unless the context clearly dictates otherwise. The present disclosure also contemplates other embodiments “comprising,” “consisting of” and “consisting essentially of,” the embodiments or elements presented herein, whether explicitly set forth or not.

As used herein, the term “about” is used to indicate that exact values are not necessarily attainable. Therefore, the term “about” is used to indicate this uncertainty limit. The term “about” may refer to plus or minus 10% of the indicated number. For example, “about 10%” may indicate a range of 9% to 11%, and “about 1” may mean from 0.9-1.1. Other meanings of “about” may be apparent from the context, such as rounding off, so, for example “about 1” may also mean from 0.5-1.4. The modifier “about” should also be considered as disclosing the range defined by the absolute values of the two endpoints. For example, the expression “from about 2 to about 4” also discloses the range “from 2 to 4.”

For the recitation of numeric ranges herein, each intervening number there between with the same degree of precision is contemplated. For example, for the range of 6-9, the numbers 7 and 8 are contemplated in addition to 6 and 9, and for the range 6.0-7.0, the numbers 6.0, 6.1, 6.2, 6.3, 6.4, 6.5, 6.6, 6.7, 6.8, 6.9, and 7.0 are contemplated. For another example, when a pressure range is described as being between ambient pressure and another pressure, a pressure that is ambient pressure is expressly contemplated.

The term “electret,” as used herein means a dielectric material that possesses a permanent or semipermanent electric polarity.

The term “partial discharge,” as used herein means a localized dielectric breakdown of a portion of a solid, liquid, or gas electrical insulation under high voltage stress.

### II. EXAMPLE COMPOSITIONS

### A. Example Electrets

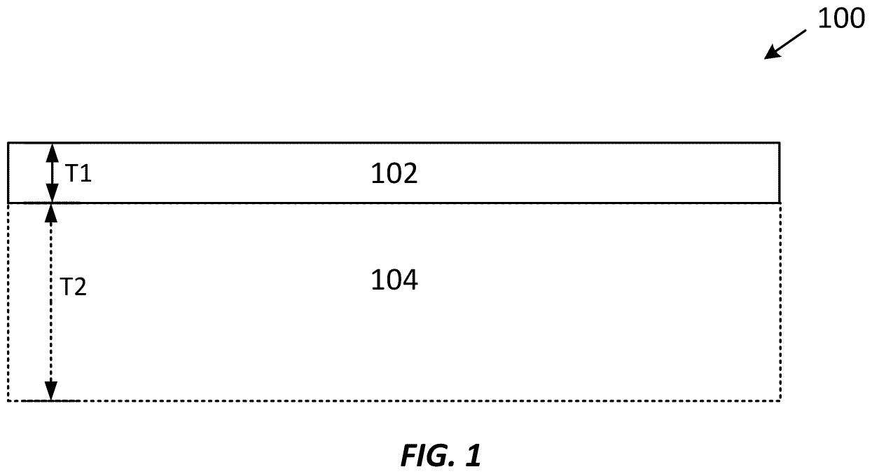

Example electrets disclosed and contemplated herein may comprise one or more components. FIG. 1 schematically illustrates a sideview of an example electret 100. Broadly, example electret 100 comprises a layer 102. In some instances, layer 102 may be a silicon nitride (Si₃N₄) layer. In other instances, layer 102 may be a Parylene layer. “Parylene,” as used herein refers to a polymer having a backbone consisting of optionally substituted para-benzenediyl rings connected by 1,2-ethanediyl bridges. Optionally, electret 100 may further comprise a second layer 104. Layer 102 may be supported by layer 104. In various instances, the second layer 104 is a silicon dioxide (SiO₂) layer.

The thickness of layer 102 and may vary depending on the application. In some instances, the layer 102 has a thickness T1 of 0.1 nm to 1 mm; 1 nm to 900 μm; 12 nm to 800 μm; 3 nm to 700 μm; 3.5 nm to 650 μm; 4 nm to 600 μm; 5 nm to 500 μm; 6 nm to 400 μm; 7 nm to 300 μm; 8 nm to 200 μm; 9 nm to 100 μm; 10 nm to 90 μm; 20 nm to 80 μm; 30 nm to 70 μm; 40 nm to 60 μm; 50 nm to 50 μm; 60 nm to 40 μm; 70 nm to 30 μm; 80 nm to 20 μm; 90 nm to 10 μm; 0.1 μm to 9 μm; 0.2 μm to 8 μm; 0.3 μm to 7 μm; 0.4 μm to 6 μm; 0.5 μm to 5 μm; 0.6 μm to 4 μm; 0.7 μm to 3 μm; 0.8 μm to 2 μm; or 0.9 μm to 1 μm. In some instances, the layer 102 has a thickness T1 of no less than 0.1 nm; no less than 1 nm; no less than 5 nm; no less than 10 nm; no less than 20 nm; no less than 30 nm; no less than 40 nm; no less than 50 nm; no less than 60 nm; no less than 70 nm; no less than 80 nm; no less than 90 nm; no less than 0.1 μm; no less than 0.2 μm; no less than 0.5 μm; no less than 0.7 μm; no less than 1 μm; no less than 2 μm; no less than 5 μm; no less than 7 μm; no less than 10 m; no less than 20 μm; no less than 50 μm; no less than 70 μm; no less than 100 μm; no less than 200 μm; no less than 500 μm; no less than 700 μm; or no less than 900 μm. In some instances, the layer 102 has a thickness T1 of no greater than 1 mm; no greater than 900 μm; no greater than 700 μm; no greater than 500 μm; no greater than 200 μm; no greater than 100 μm; no greater than 70 μm; no greater than 50 μm; no greater than 20 μm; no greater than 10 μm; no greater than 5 μm; no greater than 1 μm; no greater than 7 μm; no greater than 5 μm; no greater than 2 μm; no greater than 1 μm; no greater than 0.7 μm; no greater than 0.5 μm; no greater than 0.2 μm; no greater than 0.1 μm; no greater than 90 nm; no greater than 80 nm; no greater than 70 nm; no greater than 60 nm; no greater than 50 nm; no greater than 40 nm; no greater than 30 nm; no greater than 20 nm; no greater than 10 nm; no greater than 5 nm; no greater than 1 nm.

The thickness of the second layer 104 may vary depending on the application. In various instances, the second layer 104 has a thickness T2 of 0.1 nm to 1 mm; 1 nm to 900 μm; 12 nm to 800 μm; 3 nm to 700 μm; 3.5 nm to 650 μm; 4 nm to 600 μm; 5 nm to 500 μm; 6 nm to 400 μm; 7 nm to 300 μm; 8 nm to 200 μm; 9 nm to 100 μm; 10 nm to 90 μm; 20 nm to 80 μm; 30 nm to 70 μm; 40 nm to 60 μm; 50 nm to 50 μm; 60 nm to 40 μm; 70 nm to 30 μm; 80 nm to 20 μm; 90 nm to 10 μm; 0.1 μm to 9 μm; 0.2 μm to 8 μm; 0.3 μm to 7 μm; 0.4 μm to 6 μm; 0.5 μm to 5 μm; 0.6 μm to 4 μm; 0.7 μm to 3 μm; 0.8 μm to 2 μm; or 0.9 μm to 1 μm. In some instances, the second layer 104 has a thickness T2 of no less than 0.1 nm; no less than 1 nm; no less than 5 nm; no less than 10 nm; no less than 20 nm; no less than 30 nm; no less than 40 nm; no less than 50 nm; no less than 60 nm; no less than 70 nm; no less than 80 nm; no less than 90 nm; no less than 0.1 μm; no less than 0.2 μm; no less than 0.5 μm; no less than 0.7 μm; no less than 1 μm; no less than 2 μm; no less than 5 μm; no less than 7 μm; no less than 10 μm; no less than 20 μm; no less than 50 μm; no less than 70 μm; no less than 100 μm; no less than 200 μm; no less than 500 μm; no less than 700 μm; or no less than 900 μm. In some instances, the second layer 104 has a thickness T2 of no greater than 1 mm; no greater than 900 μm; no greater than 700 μm; no greater than 500 μm; no greater than 200 μm; no greater than 100 μm; no greater than 70 μm; no greater than 50 μm; no greater than 20 μm; no greater than 10 μm; no greater than 5 μm; no greater than 1 μm; no greater than 7 μm; no greater than 5 μm; no greater than 2 μm; no greater than 1 μm; no greater than 0.7 μm; no greater than 0.5 μm; no greater than 0.2 μm; no greater than 0.1 μm; no greater than 90 nm; no greater than 80 nm; no greater than 70 nm; no greater than 60 nm; no greater than 50 nm; no greater than 40 nm; no greater than 30 nm; no greater than 20 nm; no greater than 10 nm; no greater than 5 nm; no greater than 1 nm.

In some instances, example electrets have a surface charge density of 0.1 mC/m² to 30 mC/m². In various instances, example electrets have a surface charge density of 0.25 mC/m² to 25 mC/m²; 0.5 mC/m² to 20 mC/m²; 0.75 mC/m² to 15 mC/m²; 1 mC/m² to 10 mC/m²; or 3 mC/m² to 7 mC/m². In various instances, example electrets have a surface charge density of at least 0.1 mC/m²; at least 0.25 mC/m²; at least 0.5 mC/m²; at least 0.75 mC/m²; at least 1 mC/m²; at least 2 mC/m²; at least 3 mC/m²; at least 4 mC/m²; at least 5 mC/m²; at least 6 mC/m²; at least 7 mC/m²; at least 8 mC/m²; at least 9 mC/m²; at least 10 mC/m²; at least 15 mC/m²; at least 20 mC/m²; or at least 25 mC/m².

### B. Example Electrical Components

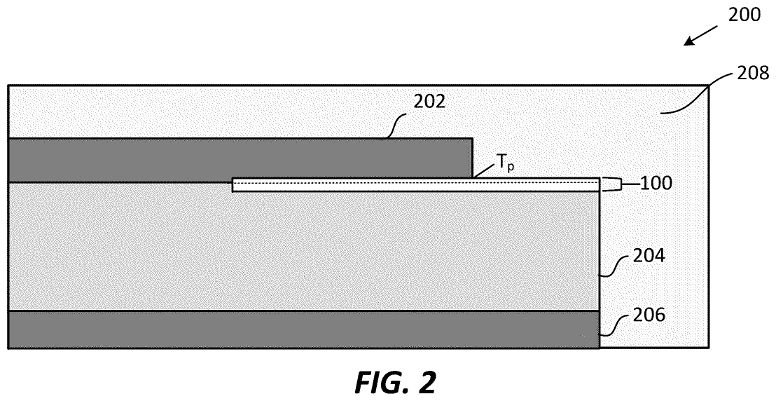

Example electrets (e.g., electret 100) may be incorporated into various example electrical components. FIG. 2 schematically illustrates a sideview portion of an example electrical component 200.

Broadly, example electrical component 200 may comprise a top conductive layer 202, an electret 100, a dielectric layer 204, a bottom conductive layer 206, and an encapsulating material 208. Other embodiments may include more or fewer components.

As shown in FIG. 2, conductive layer 202, the dielectric layer 204, and the bottom conductive layer 206 may be arranged in a stacked configuration.

In some instances, the top conductive layer 202 is referred to as the “high-voltage (HV) layer.” Example top conductive layer 202 may comprise various conductive materials. In various instances, example top conductive layer 202 comprises one or more metals, such as copper (Cu), aluminum (Al), gold (Au), silver (Ag), and combinations thereof. Example top conductive layers 202 may have a conductivity of at least 37 megasiemens per meter (MS/m).

The electret 100, described in detail above, may be interposed between a surface of the top conductive layer 202 and a surface of the dielectric layer 204. In various instances, a top surface of the electret contacts a portion of the bottom surface of the top conductive layer 202 (FIG. 2). In other instances, a top surface of the electret contacts the entire bottom surface of the top conductive layer 202 (not shown). In some instances, the electret is situated beneath, without contacting, a portion of the top conductive layer 202 (not shown). In other instances, the electret is situated beneath, without contacting, the entire the top conductive layer 202 (not shown). In some implementations, the electret 100 is adhered to the dielectric layer 204 via deposition techniques (not shown). In some instances, titanium (Ti) thin film is applied before the deposition to promote adhesion.

Various materials may be used for dielectric layer 204. The particular material(s) used for the dielectric layer may vary based on the application. In various instances, the dielectric layer 204 may comprise nitrides and oxides. Example materials include aluminum nitride (AlN), aluminum oxide (Al₂O₃), silicon nitride (Si₃N₄), zirconia toughened alumina (ZTA), and combinations thereof. In some cases, the dielectric layer 204 may comprise organic materials, such as epoxy resin, polyimide, and combinations thereof.

In various instances, the dielectric layer 204 is supported by a bottom conductive layer 206. In some instances, bottom conductive layer 206 is referred to as the “ground (GND) layer” or the “baseplate.” Example bottom conductive layer 206 may comprise various conductive materials. In various instances, example bottom conductive layer 206 comprises one or more metals, such as copper (Cu), aluminum (Al), gold (Au), silver (Ag), and combinations thereof. Example bottom conductive layer 206 may have a conductivity of at least 37 MS/m.

As further illustrated in FIG. 2, an encapsulating material 208 surrounds and contacts the exterior surface of the stacked configuration. Example encapsulating material 208 may include materials such as silicone-based materials, epoxy resin, and combinations thereof. Example silicone-based materials may include silicone gel and/or silicone rubber.

In example electrical component 200, the top conductive layer 202, the electret 100, and the encapsulating material 208 may intersect at a triple point (Tₚ). The term “triple point” or “triple point edge,” as used herein, means a locus at which three different materials coexist.

### III. EXAMPLE APPLICATIONS

Example electrical components may be incorporated in various power substrates, power electronic modules, and laminated busbars.

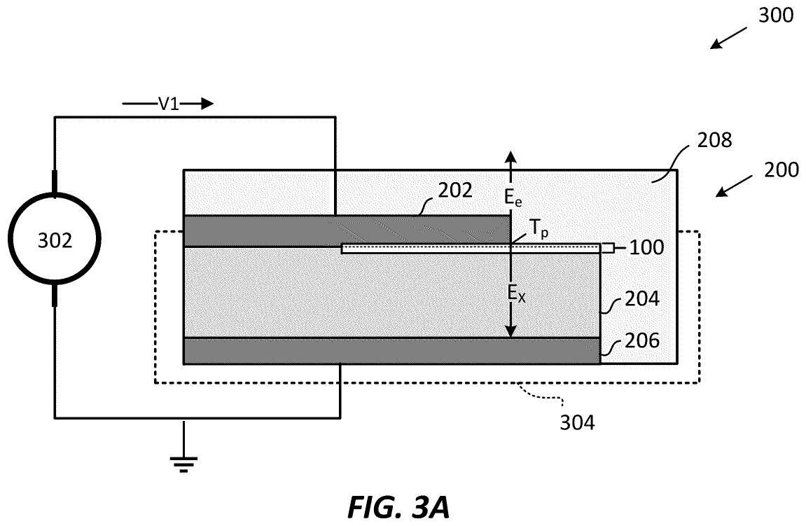

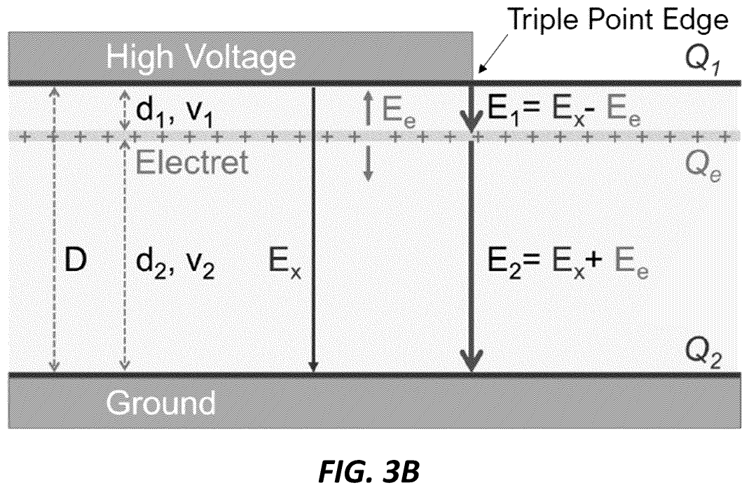

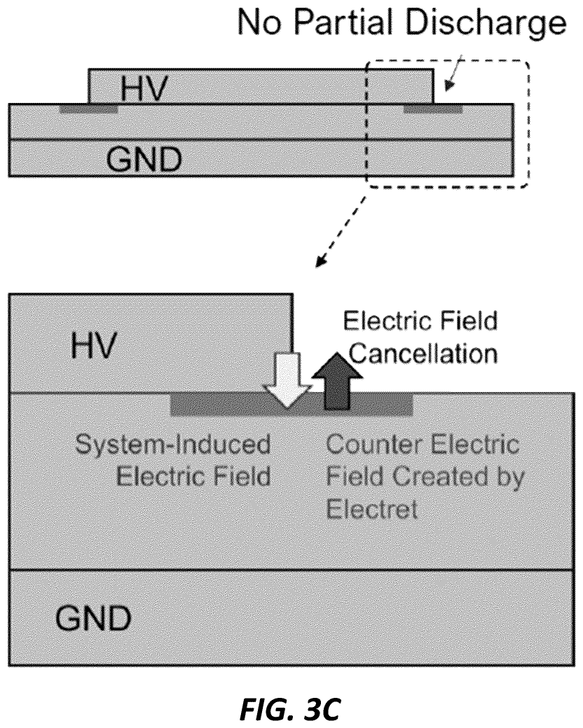

In some instances, example electrical components are incorporated in various electronic circuits 300. FIG. 3A is a schematic illustrating an example electronic circuit 300. Example electronic circuit 300 comprises electrical component 200, described in detail above, and voltage source 302. Particularly in a power module application, various power semiconductor devices, such as silicon carbide (SiC) metal-oxide-semiconductor field-effect transistors (MOSFETs), may be attached on top of the top conductive layer 202. Optional components are shown in dotted outline. Other embodiments may include more or fewer components. The configuration of electronic circuit 300 may vary depending on the specific implementation.

In some implementations, the electronic circuit 300 may further include temperature regulation components 304 configured to maintain a predetermined temperature of electrical component 200. In various instances, Example temperature regulation component may maintain a electrical component 200 temperature of from 20° C. to 250° C. In various instances, Example temperature regulation component may maintain an electrical component 200 temperature of from 25° C. to 245° C.; 40° C. to 240° C.; 50° C. to 230° C.; 75° C. to 225° C.; 100° C. to 200° C.; 110° C. to 190° C.; 120° C. to 180° C.; 125° C. to 175° C.; 130° C. to 170° C.; or 140° C. to 160° C. In various instances, Example temperature regulation component may maintain an electrical component 200 temperature of no greater than 250° C.; no greater than 225° C.; no greater than 200° C.; no greater than 175° C.; no greater than 150° C.; no greater than 125° C.; no greater than 100° C.; no greater than 75° C.; or no greater than 50° C. In various instances, Example temperature regulation component may maintain an electrical component 200 temperature of no less than 25° C.; no less than 50° C.; no less than 75° C.; no less than 100° C.; no less than 125° C.; no less than 150° C.; no less than 175° C.; no less than 200° C.; or no less than 225° C.

During typical operation, the electret 100 will neutralize or reduce the electric field at the triple point Tₚ (FIG. 3A). In some instances, the electric field at the triple point Tₚ is less than the partial discharge inception voltage (PDIV). As used herein, the term “partial discharge inception voltage (PDIV)” means the voltage level required to initiate partial discharge (PD). The voltage level required to initiate partial discharge may be a voltage of above 100 V. In some instances, the electric field at the triple point Tₚ is about zero. In various implementations, the top conductive layer 202 will show recurring, steep square voltage pulses, also known as pulse width modulated (PWM) voltage waves, due to the switching of power semiconductors attached on top of the top conductive layer 202 (not shown). When the power semiconductors are inactive, the top conductive layer 202 will show DC voltage. Assuming the voltage source 302 provides voltage V1 to the top conductive layer 202 while the bottom conductive layer 206 is electrically grounded, the electret 100 can be designed to generate electric field Eₑ to counter Eₓ created by V1. Electric fields at the triple point Tₚ are neutralized when Eₑ and Eₓ have the same magnitude (i.e., Eₓ−Eₑ=0).

FIGS. 3B-3C illustrate the electric field neutralization achieved along triple point edges via field cancellation enabled by the electret. FIG. 3B is a schematic illustrating the physical model variables used to quantify the electric field at the triple point edge of example electrical component 200. As shown in FIG. 3B, the surface charges on the top and bottom conductive layer surfaces are Q₁ and Q₂, respectively. Assuming that all layers have an equal surface area, A, and the surface charge density of the electret film is σₑ, the total surface charge of the electret is Qe=σₑA. While the electric field generated from the top conductive layer, Eₓ, points towards the bottom surface, the electric field of the electret, Eₑ points toward the top and bottom surfaces (FIG. 3B). In Example applications, such as Example electronic circuit 300, Eₓ−Eₑ equals zero, thus eliminating E₁.

The potential difference between the top and bottom conductive layer surfaces is:

$$v = {v}_{1} - {v}_{2} \qquad ( 1 )$$

The net charge of a system is zero because the charge induced on the bottom (Q₁) and top (Q₂) surfaces, and the overall charge of the electret layer (Qₑ) are equal in magnitude but reverse in polarity.

$${Q}_{1} + {Q}_{2} + {Q}_{3} = 0 \qquad ( 2 )$$

Based on the capacitance between v₁ and v₂, (2) can be rewritten as follows.

$${C}_{1} {v}_{1} + {C}_{2} {v}_{2} + {Q}_{e} = 0 \qquad ( 3 )$$

Applying the definition of capacitance, (3) can be rewritten as follows.

$$\frac{{ϵ}_{0} {ϵ}_{r 1} {Av}_{1}}{{d}_{1}} + \frac{{ϵ}_{0} {ϵ}_{r 2} {Av}_{2}}{{d}_{2}} + {σ}_{e} A = 0 \qquad ( 4 )$$

As shown in FIG. 3B, the electric field under the triple point E₁ can be neutralized by the electric field of the electret Eₑ countering Eₓ. The required surface charge density of the electret that satisfies the E₁=0 condition is derived as follows.

$${σ}_{e} = \frac{{ϵ}_{0} {ϵ}_{r 2} v}{{d}_{2}} \qquad ( 5 )$$

### IV. METHODS

Various example methods known to those of skill in the art, e.g., triode corona charging, may be used to prepare example electrets.

Example methods of manufacturing electrets described and contemplated herein may comprise providing a substrate. The substrate may be any suitable substrate. In some instances, the substrate is a metal-based substrate, e.g., an aluminum (Al) substrate. In some instances, the substrate further comprises a thin layer of a material, e.g., titanium (Ti), to improve adhesion between the substrate and the thin film.

After providing the substrate, example methods of manufacturing electrets may further comprise depositing a thin film onto the substrate. The thin film may be deposited onto the substrate via sputtering and electron beam evaporation.

In some instances, the thin film comprises the silicon nitride (Si₃N₄) layer supported by the silicon dioxide (SiO₂) layer. The silicon nitride (Si₃N₄) layer may have a thickness of 0.1 nm to 1 mm. The silicon dioxide (SiO₂) layer may have a thickness of 0.1 nm to 1 mm. In other instances, the thin film comprises the Parylene layer. The Parylene layer may have a thickness of 0.1 nm to 1 mm.

After depositing the thin film onto the substrate, example methods of manufacturing electrets may further comprise triode corona charging the thin film, thereby providing the electret. Specifically, the triode corona charging process embeds positive or negative charge carriers in the thin film materials. The triode corona charging process may implement two voltage levels—a high voltage level and a low voltage level. In triode corona charging, the high voltage level generates charge carriers by ionizing gas, and the low voltage generates a uniform electric field that uniformly embeds charge carriers, created by the high voltage, in the electret base materials.

The high voltage may be greater than 1 kV. In some instances, the high voltage may be greater than 1.2 kV; greater than 1.3 kV; greater than 1.4 kV; greater than 1.5 kV; greater than 1.6 kV; greater than 1.7 kV; greater than 1.8 kV; or greater than 1.9 kV.

The low voltage may be greater than 0.2 kV and less than 1 kV. In some instances, the low voltage may be 0.25 kV to 0.75 kV; 0.3 kV to 0.7 kV; 0.35 kV to 0.65 kV; 0.4 kV to 0.6 kV; or 0.45 kV to 0.55 kV. In some instances, the low voltage may be greater than 0.2 kV; greater than 0.3 kV; greater than 0.4 kV; greater than 0.5 kV; greater than 0.6 kV; greater than 0.7 kV; greater than 0.8 kV; or greater than 0.9 kV. In some instances, the low voltage may be less than 1 kV; less than 0.9 kV; less than 0.8 kV; less than 0.7 kV; less than 0.6 kV; less than 0.5 kV; less than 0.4 kV; or less than 0.3 kV.

During triode corona charging, the thin films may be charged at a temperature of 25° C. to 400° C. In some instances, the thin films are charged at a temperature of 30° C. to 350° C.; 40° C. to 325° C.; 50° C. to 300° C.; 60° C. to 275° C.; 70° C. to 250° C.; 80° C. to 225° C.; 90° C. to 200° C.; 100° C. to 175° C.; or 110° C. to 150° C. In some instances, the thin films are charged at a temperature of no greater than 400° C.; no greater than 350° C.; no greater than 300° C.; no greater than 250° C.; no greater than 200° C.; no greater than 150° C.; no greater than 100° C.; no greater than 75° C.; or no greater than 50° C. In some instances, the thin films are charged at a temperature of no less than 25° C.; no less than 50° C.; no less than 75° C.; no less than 100° C.; no less than 150° C.; no less than 200° C.; no less than 250° C.; no less than 300° C.; or no less than 350° C.

During triode corona charging, the thin films may be charged for a period of 10 minutes to 4 hours. In some instances, the thin films may be charged for a period of 20 minutes to 3.5 hours; 30 minutes to 3 hours; 45 minutes to 2.5 hours; or 1 hour to 2 hours. In some instances, the thin films may be charged for a period of no greater than 4 hours; no greater than 3 hours; no greater than 2 hours; no greater than 1 hour; or no greater than 30 minutes. In some instances, the thin films may be charged for a period of no less than 10 minutes; no less than 20 minutes; no less than 30 minutes; no less than 1 hour; no less than 2 hours; or no less than 3 hours.

Example electrical components may also be manufactured using methods known to those of skill in the art. Example electrical components may be constructed in various ways depending on the specific electrical component and intended use for said component.

### V. EXPERIMENTAL EXAMPLES

Without limiting the scope of the instant disclosure, experimental examples of embodiments discussed above were prepared and the results are discussed below.

### Methods

### A. SiO₂/Si₃N₄ Electret

### 1. Electret Fabrication

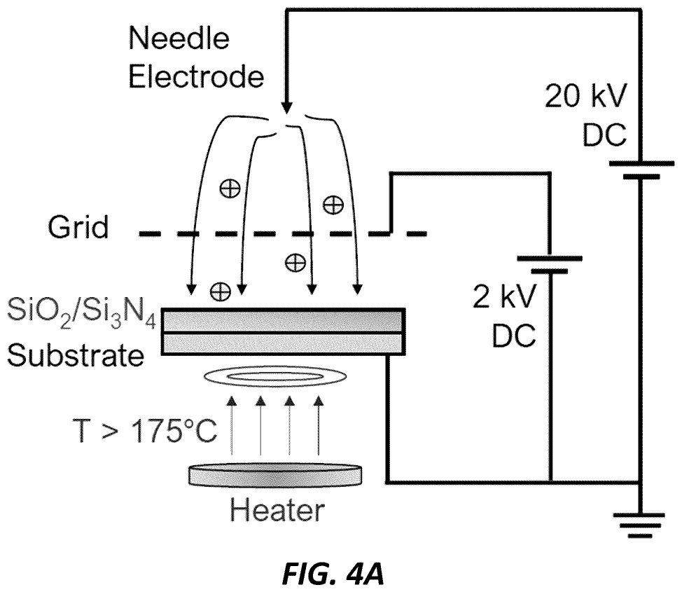

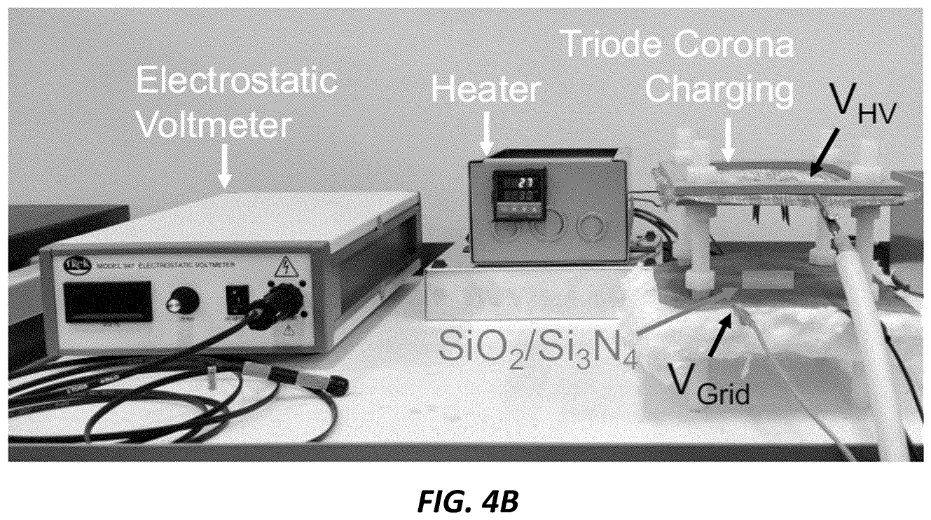

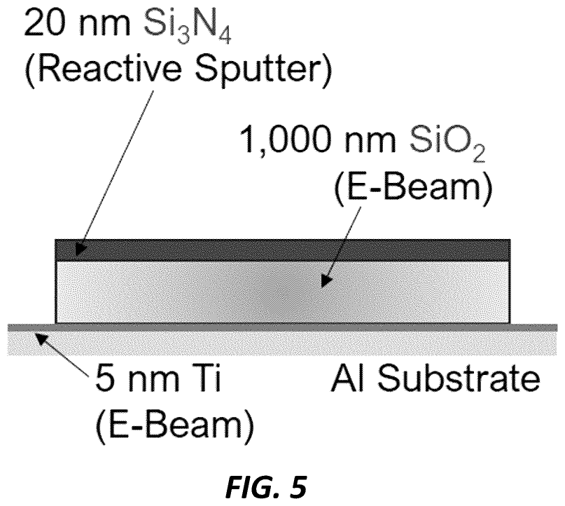

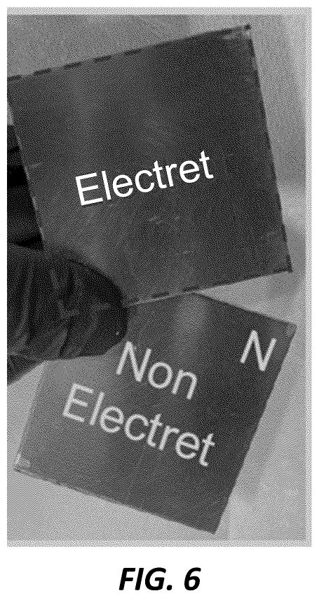

Thin film electrets were fabricated by triode corona charging 1,025 nm SiO₂/Si₃N₄ thin films deposited by sputtering and electron-beam evaporation. FIGS. 4A-4B depict the schematic and experimental setup used to fabricate SiO₂/Si₃N₄ electrets. FIG. 5 is an illustration depicting the thin film layers of SiO₂/Si₃N₄ deposited on an aluminum (Al) substrate. First, the A1 substrate was ion beam milled, and a 5 nm titanium (Ti) intermediate layer was deposited to improve adhesion. Subsequently, 1,000 nm SiO₂ and 20 nm Si₃N₄ thin films were deposited on top of the Ti layer via electron-beam evaporation and reactive sputtering. Using these SiO₂/Si₃N₄ thin films, thin film electrets were fabricated using the triode corona charging setup shown in FIGS. 4A-4B. Two voltage levels, 20 kV and 2 kV, were applied to the needle electrode and the copper grid, respectively. The high voltage at the needle electrode generated positive and negative charged particles. The grid voltage generated electric fields that forced positive ion particles to penetrate into the SiO₂/Si₃N₄ thin films uniformly. Corona charging the thin films at higher temperatures enabled charged particles to penetrate into the deeper traps, improving charge density and stability. Here, the SiO₂/Si₃N₄ thin films were charged at 260° C. for 15 minutes and continued to charge while they cooled down for 20 minutes. FIG. 6 is a photograph of one of the thin film electrets fabricated. After corona charging, the SiO₂/Si₃N₄ electrets were placed on an electrically grounded surface to measure the surface potential using an electrostatic voltmeter (Trek Model 347). The surface charge density of electrets derived from the surface potential measurement was 3.37 mC/m².

### 2. Partial Discharge (PD) Testbed

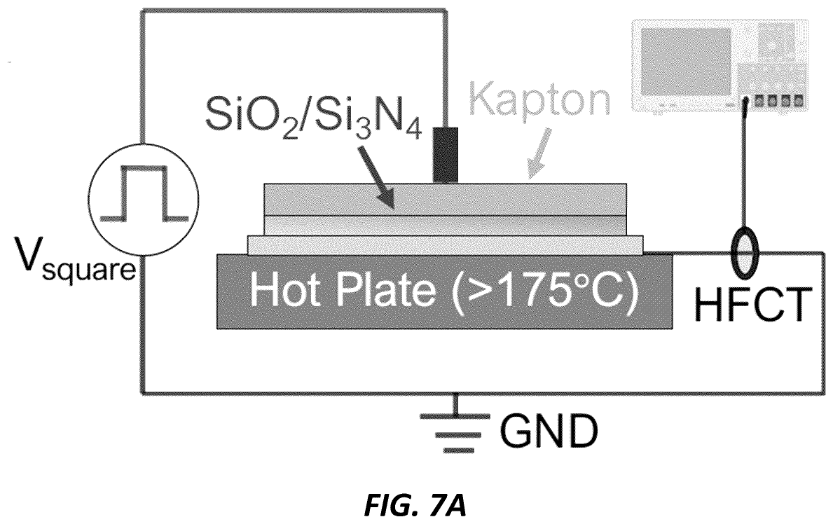

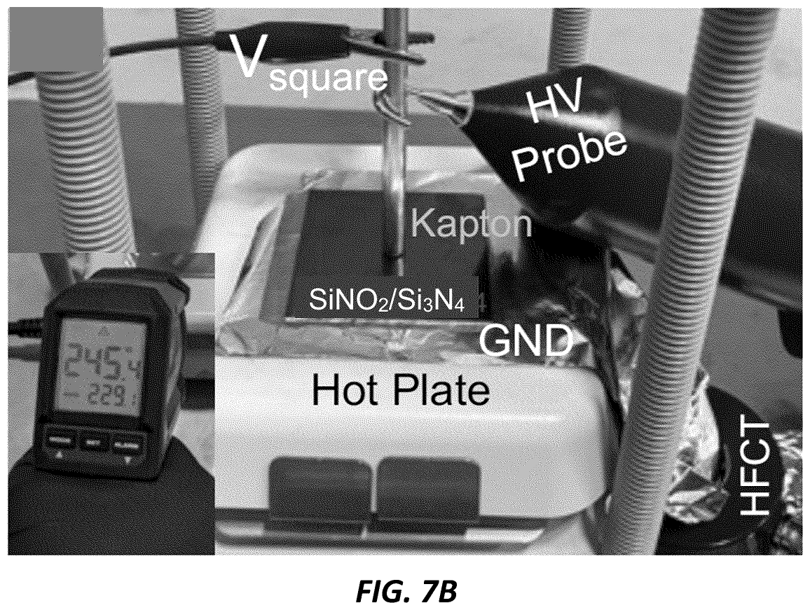

Experiments were conducted to demonstrate the effectiveness of the SiO₂/Si₃N₄ electrets in mitigating PD at high operating temperatures. FIGS. 7A-7B is a schematic of the experimental setup used in the study. The experiment consists of a square voltage pulse source (Vsquare), hot plate, SiO₂/Si₃N₄ thin film, kapton sheet, high-frequency current transformer (HFCT), HV probe, and an oscilloscope. The square voltage pulse supply (Matsusada Model SK-10P) generated 1 kV, 1.1 kV, and 1.2 kV square voltage pulses with the rise and fall time of 16 ns. The samples were placed on the hot plate, and the PD measurements were performed at 25° C., 175° C., and 245° C. It should be noted that the 1,020 nm thick SiO₂/Si₃N₄ film was designed for PD mitigation but not as a main dielectric that can withstand high voltages. Hence, as shown in FIG. 7A, a 25.4 μm thick Kapton sheet, serving as a main dielectric, was placed on top of the SiO₂/Si₃N₄ thin film. During the experiments, the surface temperature of the Kapton layer were measured via a temperature gun. The HFCT with a bandwidth of 400 MHz was placed in the ground path to measure the PD current flowing through the circuit. A 39 kV rated voltage probe with a bandwidth of 220 MHz (Cal Test Electronics CT4028) was connected to the high-voltage electrode to measure the steep square voltage pulses. Based on this experimental setup, the PD of the non-electret and electret samples were measured and compared.

### 3. PD, Switching Noise Separation

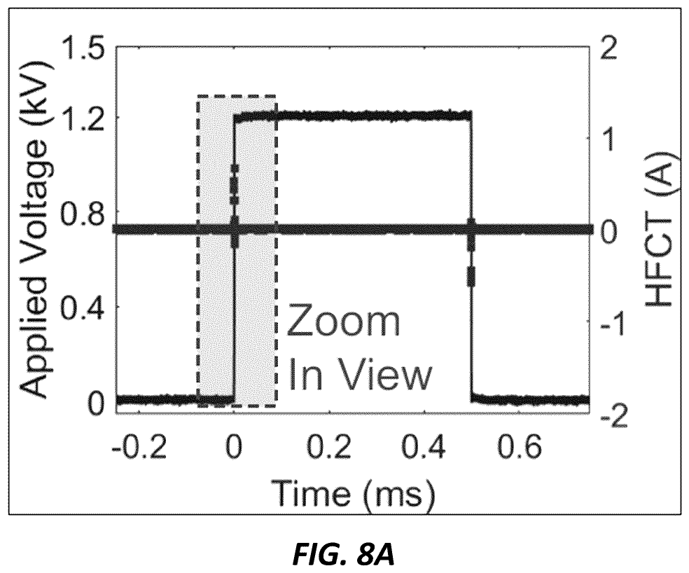

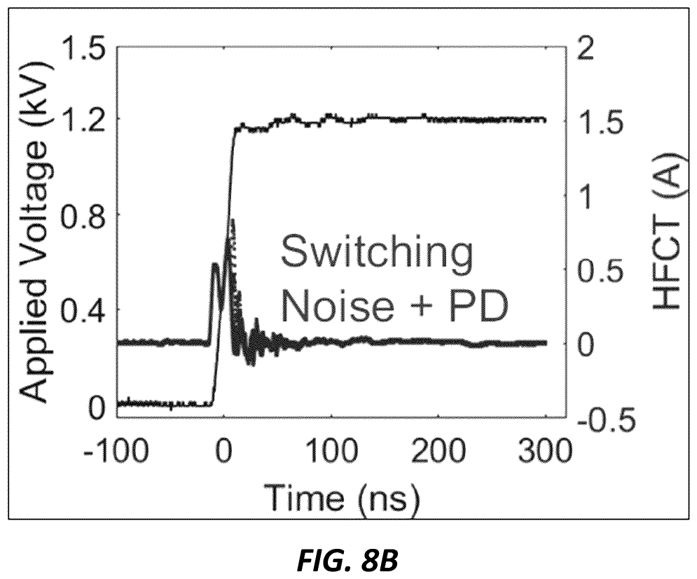

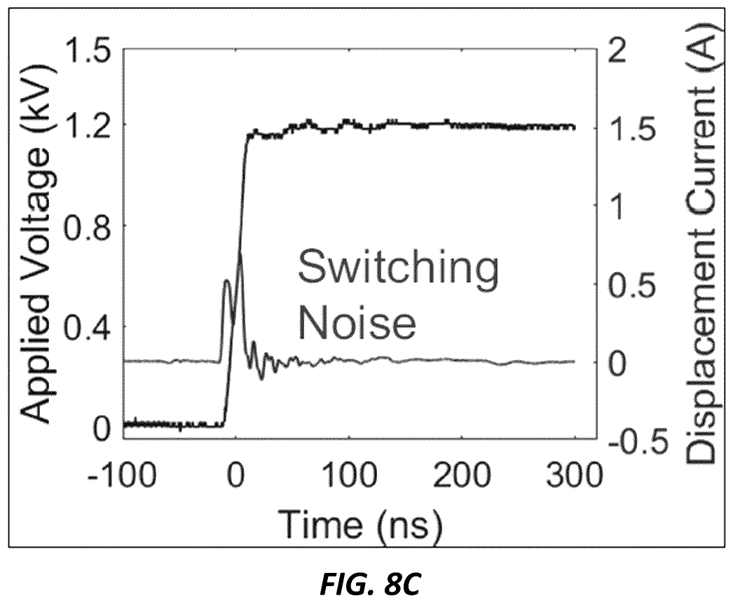

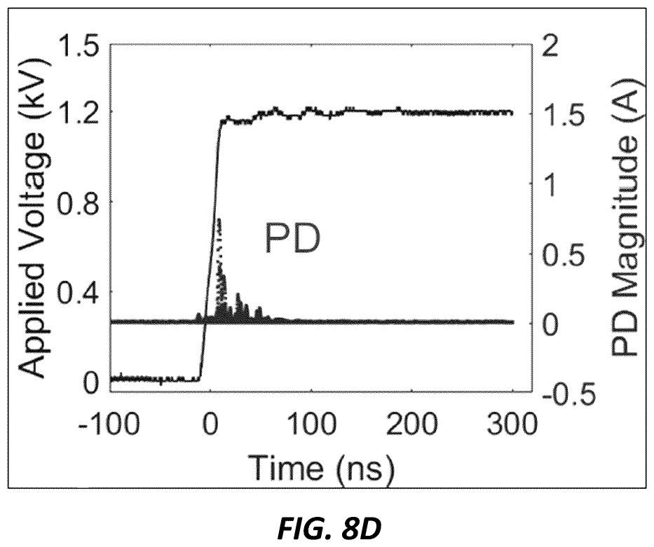

Current flowing through the ground path of the PD testbed measured by the HFCT includes PD and switching noise induced by the steep rising and falling edges of the square voltage pulses. It has been observed that PD mainly occurs on the rising and falling edges of square voltage pulses, which renders distinguishing PD signals from switching noises difficult. The measurements concur that PD and switching noise mainly occur around the rising and falling edges as shown in FIG. 8A. Here, a simple yet effective approach to separate the PD signals from the switching noise is employed. Averaging multiple cycles of current waveforms amplifies repetitive features compared to the features that are irregular and less repetitive. This approach was applied since switching noise is a repetitive current pulse induced by steep rising and falling voltage edges while PD magnitude and rate vary randomly. FIGS. 8A-8C show how the switching noise and PD from the current measured were separated via an HFCT. A single cycle of a square voltage pulse and current measured is presented in FIG. 8A.

The frequency of the square voltage pulse was 1 kHz with rise and fall times of 16 ns. As discussed earlier, current signals that consist of PD and switching noise are concentrated around the rising and falling edges of the square voltage pulse. FIG. 8B shows the zoom-in view of the rising edge of FIG. 8A. Here, the red curves include PD and switching noise, but the two are hardly distinguishable. To extract the switching noise shown in FIG. 8C, the average of 60 current waveform datasets was taken. Then the switching noise was subtracted from the total current shown in FIG. 8B to obtain the pure PD waves shown in FIG. 8D. One should note that the PD and switching noise separation performance improves with the number of waveform datasets integrated because the repetitive switching noise will become more amplified, while the irregular PD signals do not.

### B. Parylene Electret

### 1. Electret Fabrication

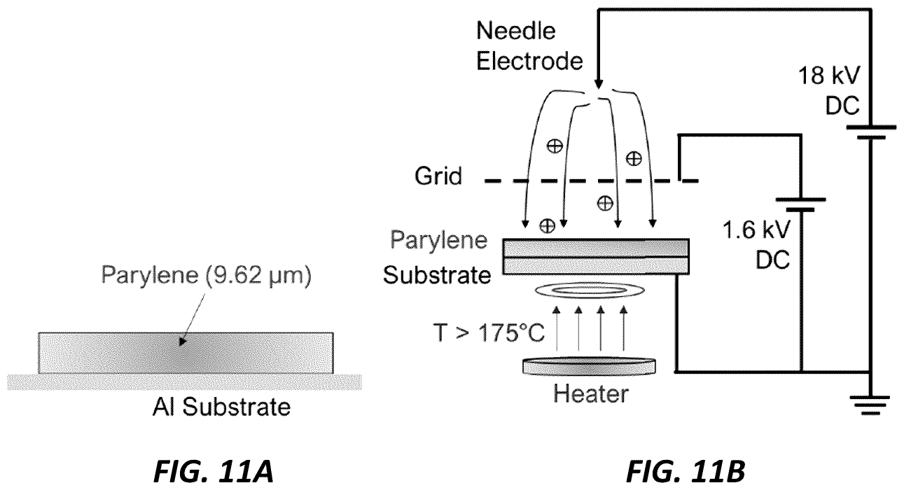

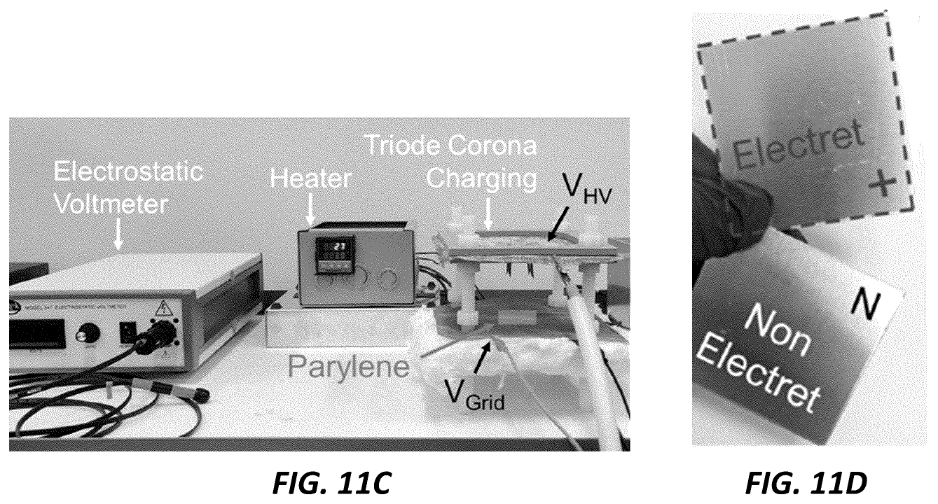

Parylene HT® thin film electrets were fabricated by charging 9.62 μm Parylene HT® thin films deposited by Specialty Coating Systems (SCS) using the triode corona method. The schematic and experimental setup used to fabricate Parylene HT® electrets are shown in FIGS. 11A-11C. FIG. 11A is a 9.62 μm thin film layer of Parylene HT® deposited on an aluminum (Al) substrate. Using these thin films, Parylene thin film electrets were fabricated through the triode corona charging testbed shown in FIGS. 11B-11C. 18 kV and 1.6 kV were applied to the needle electrode and the copper grid, respectively. Positive and negative charge carriers were produced by the 18 kV applied at the needle electrode. Positive carriers were accelerated uniformly via the 1.6 kV applied to the grid voltage and bombarded the Parylene HT® thin films. Higher temperatures were maintained during corona charging to allow charge carriers to reach deep traps, increasing charge density and stability. The Parylene HT® thin films were charged at 260° C. for 30 minutes and continued to charge while they cooled down for 30 minutes. The fabricated thin film electrets are shown in FIG. 11D. Once fabricated, the Parylene HT® electrets were placed on an electrically grounded surface to measure the surface potential with an electrostatic voltmeter (Trek Model 347). Subsequently, the surface charge density of electrets was derived to be 2.48 mC/m² using known methods.

### 2. Partial Discharge (PD) Testbed

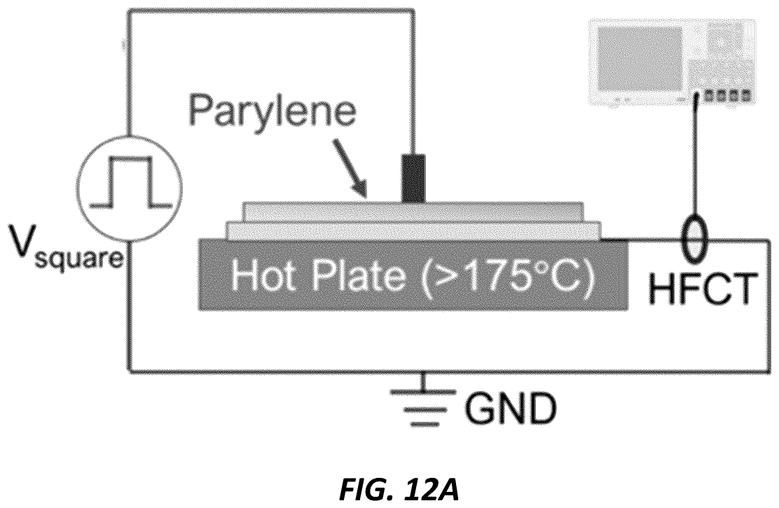

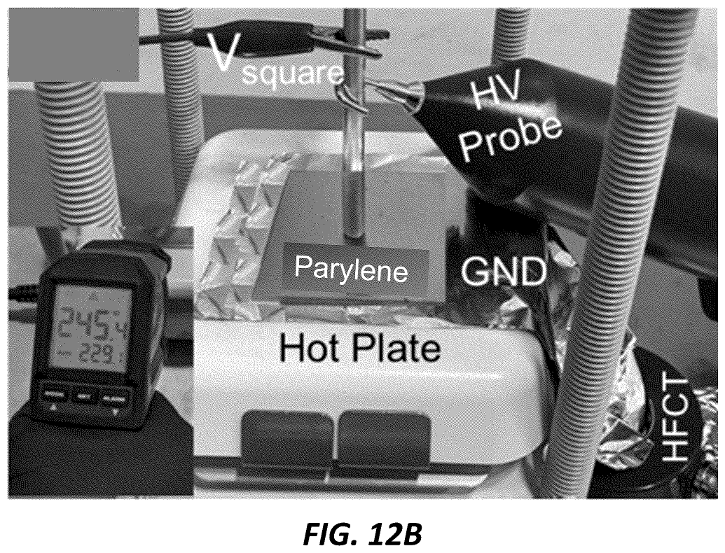

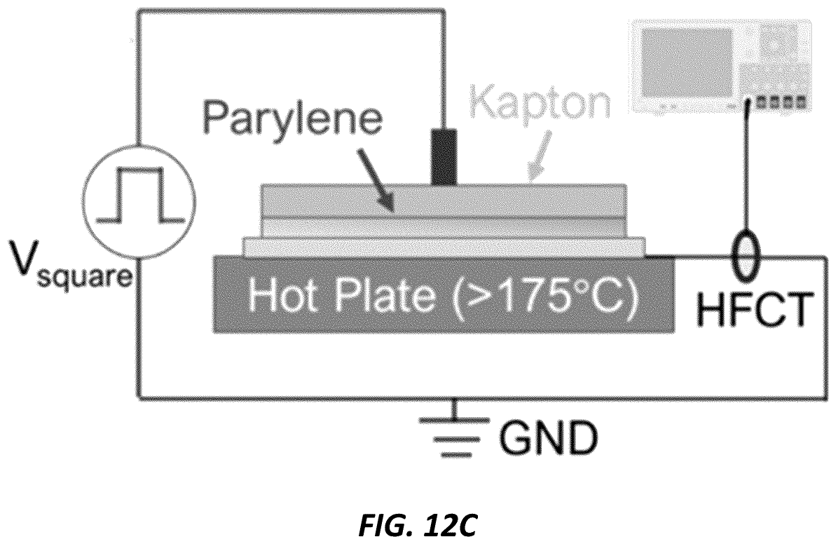

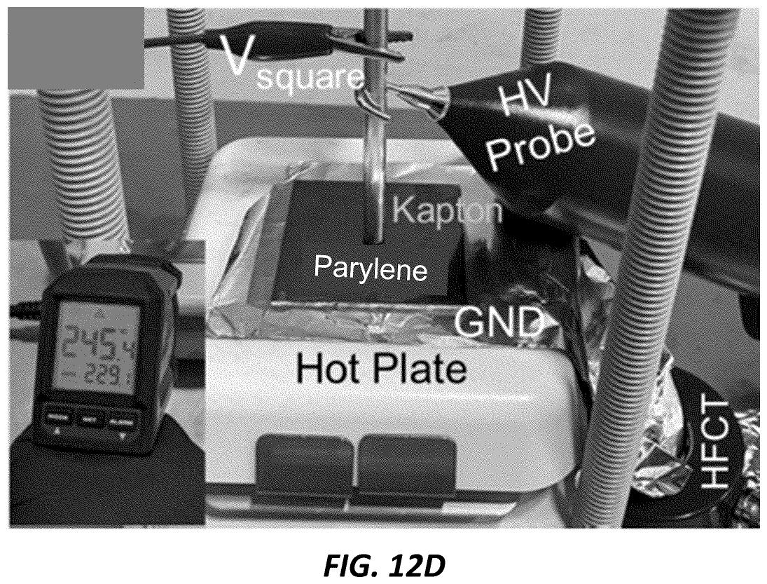

PD experiments were conducted to assess how effectively Parylene electrets reduce PD under steep voltage pulses at high temperatures. As depicted in FIGS. 12A-12D the experiment includes a square voltage pulse source (V_{square}), hot plate, Parylene thin film, Kapton sheet, high-frequency current transformer (HFCT), HV probe, and an oscilloscope. A square voltage pulse supply (Matsusada Model SK-10P) was used to generate square voltage pulses with high slew rates (75 V/ns). PD was measured at 25° C., 175° C., and 260° C. It should be noted that the 9.62 μm thick Parylene electret film is primarily designed to reduce high electric fields and PD. In other words, it may or may not serve as a main dielectric. In the experiment, the PD of two distinct cases was measured and compared: i) using only a Parylene thin film and ii) with a 25.4 μm thick Kapton film, serving as a main dielectric, placed on top of a Parylene thin film as illustrated in FIGS. 12A-12D. During the experiments, a temperature gun was used to measure the surface temperature of either the Parylene or Kapton layer. A 400 MHz HFCT was placed in the ground path to measure PD, and a 39 kV rated voltage probe with a bandwidth of 220 MHz (Cal Test Electronics CT4028) was connected to the high-voltage electrode to measure the steep square voltage pulses.

### 3. PD, Signal Separation

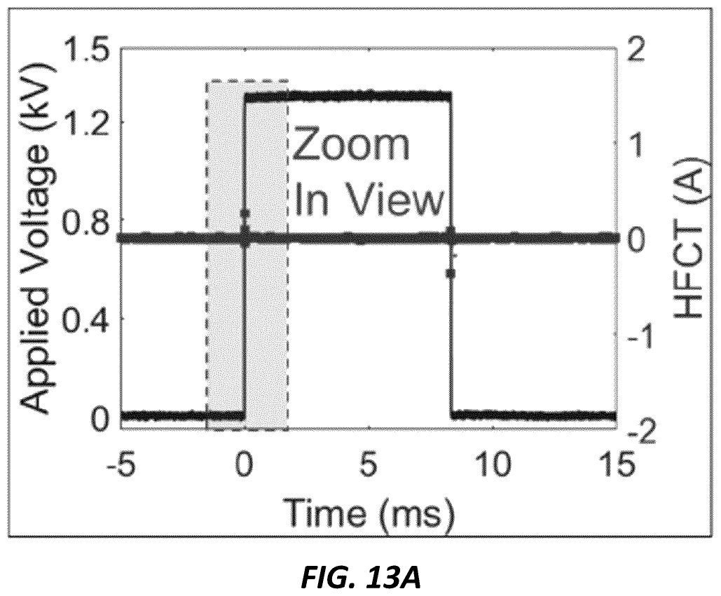

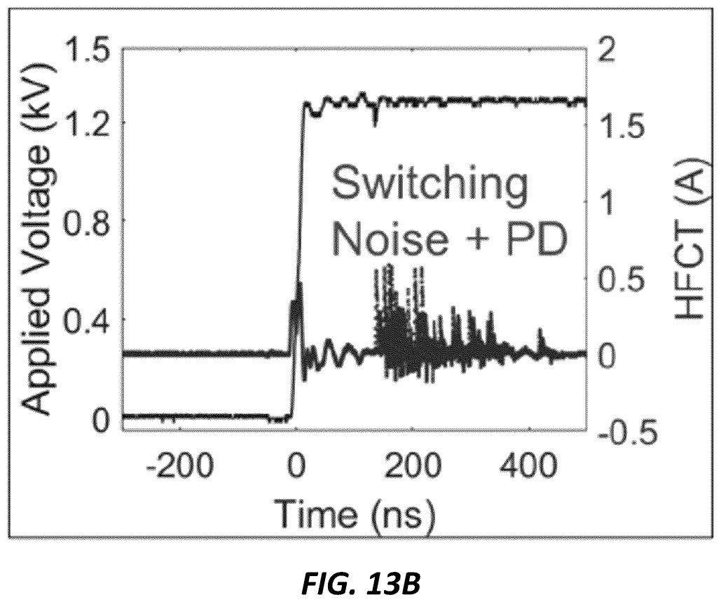

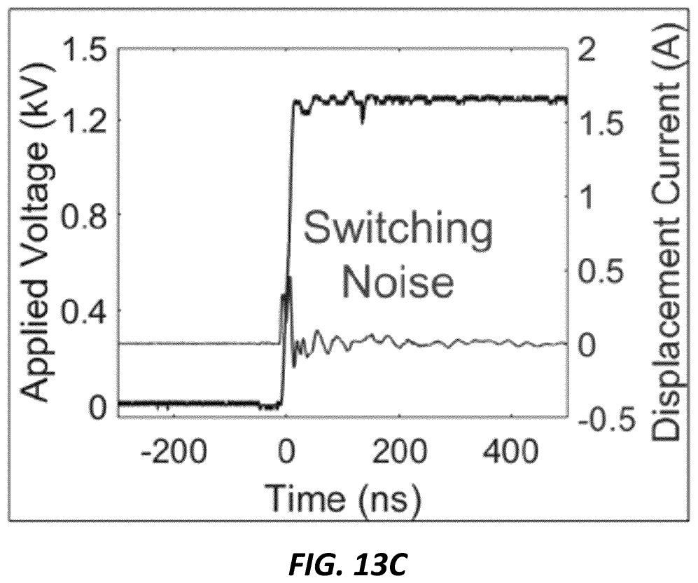

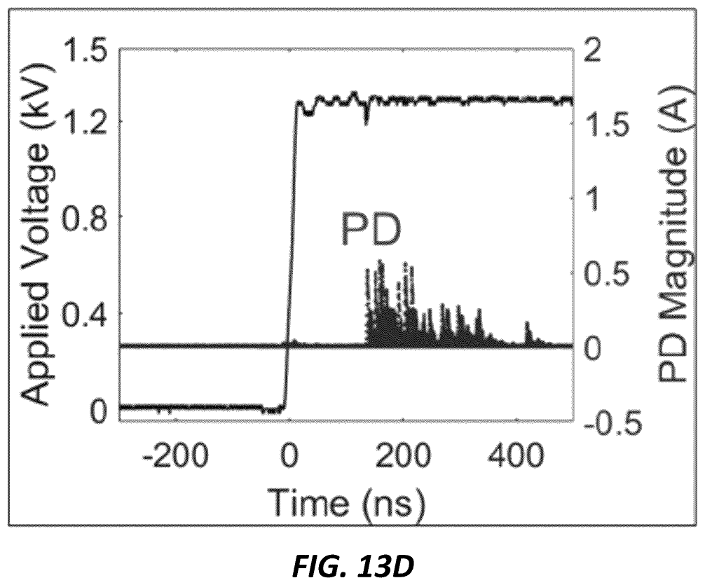

Studies reported in the literature suggest that PD mainly appears at the rising and falling edges of square voltage pulses. PD signal and switching noise induced by the steep rising and falling edges of the square voltage pulses concur and render separating the two challenging. Our measurements agree with these studies as shown in FIGS. 13A-13B. confirming that PD and switching noise occur mainly near the rising and falling edges. In this study, the current measured via an HFCT was averaged over 40 cycles to amplify repeating features (i.e., switching noise) while muting irregular and random current waveform features (i.e., PD). Once the switching noise component was amplified as shown in FIG. 13C. it was subtracted from the total measured current to separate PD signals as shown in FIG. 13D. This method works well since switching noise is highly correlated to the rising and falling edges of voltage waves, hence consistent, while PD magnitude and PD rate vary arbitrarily. Accordingly, the performance of PD and switching noise separation improves with the number of waveform averaged.

### Results

### A. SiO₂/Si₃N₄ Electret

### 1. Reduced PD at High Temperatures

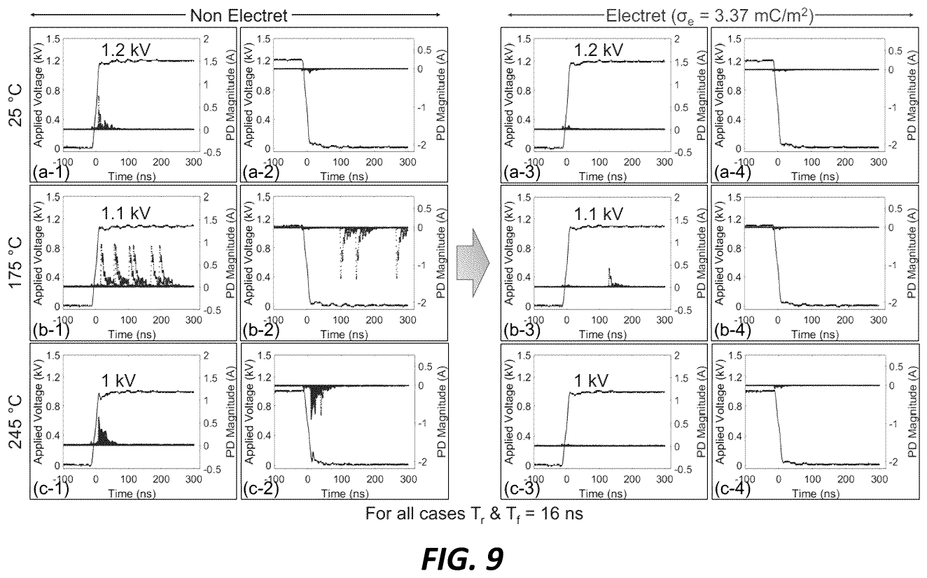

PD measurements were conducted with steep square voltage pulses at 25° C., 175° C., and 245° C. The results are shown in FIG. 9. The non-electret and electret in FIG. 9 refer to the uncharged and charged SiO₂/Si₃N₄ thin films, respectively. The 1.2 kV, 1.1 kV, and 1 kV presented in FIG. 9 are voltage levels slightly above the PDIV of the non-electret at 25° C., 175° C., and 245° C., respectively. For all voltage magnitudes, the rising and falling times of the square voltage pulses were 16 ns, which translates to the slew rate of 75 V/ns, 68.75 V/ns, and 62.5 V/ns, respectively.

PD measured from non-electret and electret test coupons at 25° C. are shown in FIG. 9(a-1) through (a-4). The maximum PD magnitudes measured from the non-electret sample at the rising and falling edges are 0.74 A and −0.12 A, respectively, as shown in FIGS. 9(a-1) and (a-2). On the other hand, the maximum PD magnitudes measured from the electret sample at the rising and falling edges are 0.089 A and −0.056 A, respectively, as shown in FIGS. 9(a-3) and (a-4). These results suggest that the SiO₂/Si₃N₄ thin film electrets reduced PD at the rising and falling edges by 88% and 53%, respectively. Moreover, PD measured from non-electret and electret test coupons at 175° C. are shown in FIG. 9(b-1) through (b-4). The maximum PD magnitudes measured from the non-electret sample at the rising and falling edges are 0.962 A and −1.38 A, respectively, as shown in FIGS. 9(b-1) and (b-2). On the other hand, the maximum PD magnitudes measured from the electret sample at the rising and falling edges are 0.41 A and −0.07 A, respectively, as shown in FIGS. 9(b-3) and (b-4). These results suggest that the SiO₂/Si₃N₄ thin film electrets reduced PD at the rising and falling edges by 57% and 95%, respectively.

Furthermore, PD measured from non-electret and electret test coupons at 245° C. are shown in FIG. 9(c-1) through (c-4). The maximum PD magnitudes measured from the non-electret sample at the rising and falling edges are 0.60 A and −0.91 A, respectively, as shown in FIGS. 9(c-1) and (c-2). Whereas the maximum PD magnitudes measured from the electret sample at the rising and falling edges are 0.04 A and −0.08 A, respectively, as shown in FIGS. 9(c-3) and (c-4). These results suggest that the SiO₂/Si₃N₄ thin film electrets reduced PD at the rising and falling edges by 93% and 91%, respectively. In short, the SiO₂/Si₃N₄ thin film electrets with the surface charge density of 3.37 mC/m² effectively mitigated PD caused by steep (i.e., high-dv/dt) square voltage pulses at all temperatures. The inorganic thin film electrets demonstrated the PD mitigating performance at temperatures above 175° C. for the first time.

### 2. Increased PDIV at High Temperatures

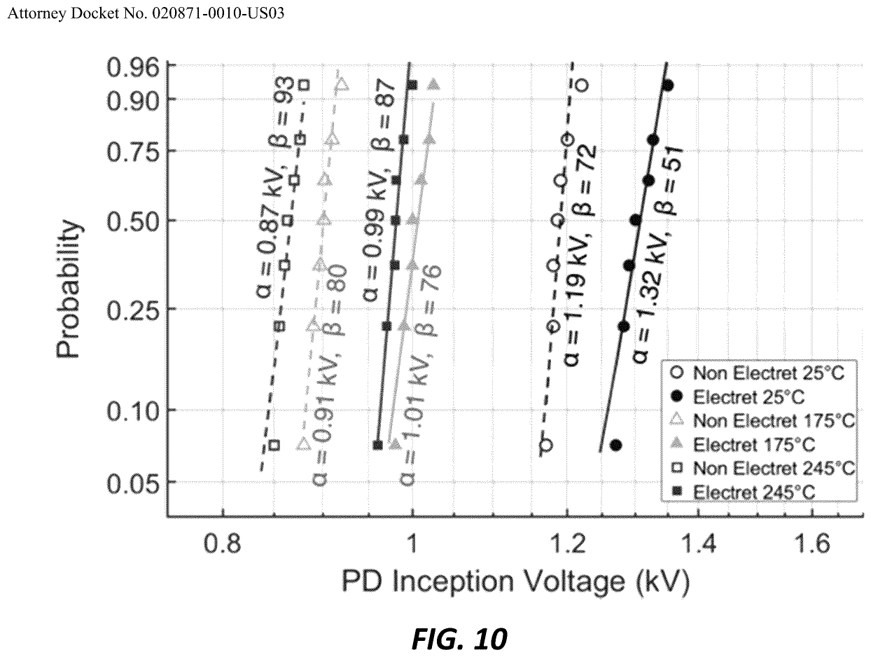

Experiments were conducted to measure and compare the partial discharge inception voltage (PDIV) of the non-electret and electret test coupons at 25° C., 175° C., and 245° C. In all cases, 1 kHz square voltage pulses were applied. The magnitude of the square voltage pulses was increased until PD signals started to appear. The PDIV measurement was repeated seven times. FIG. 10 depicts the Weibull distribution of the PDIVs measured in this study. The two-parameter Weibull function is defined as

$$P ( {U}_{i} ) = 1 - exp [ - {( \frac{{U}_{i}}{α} )}^{β} ] \qquad ( 6 )$$

where P is the cumulative failure probability and Uᵢ is the measured breakdown voltage. The 63.2% cumulative probability of PDIV is denoted by the scale parameter α. The shape parameter β denotes the distribution width, where a smaller δ value indicates a greater scatter in a dataset. Equation (6) can be rewritten as follows

$$log \{ - ln [ 1 - P ( {U}_{i} ) ] \} = β log ( {U}_{i} ) - β log ( α ) \qquad ( 7 )$$

Based on the equation above, the scale parameter α and shape parameter β are obtained through the linear regression of log{−ln[1−P(Uᵢ)]} vs. log(Uᵢ). The scale parameter α is used to represent the PDIV of respective experiments. At 25° C., the α and β values for the non-electret samples were 1.19 kV and 72, respectively, and those for the electret samples were 1.32 kV and 51, respectively. The α values indicated that the SiO₂/Si₃N₄ thin film electret increased PDIV by 10.9% at 25° C. Similarly, at 175° C., the α and β values for the non-electret samples were 0.91 kV and 80, respectively, and those for the electret samples were 1.01 kV and 76, respectively. At 175° C., the SiO₂/Si₃N₄ thin film electret increased PDIV also by 10.9%. Furthermore, at 245° C., the α and 8 values for the non-electret samples are 0.87 kV and 93, respectively, and those of the electret samples were 0.99 kV and 87, respectively. At 245° C., the SiO₂/Si₃N₄ thin film electret increased PDIV by 13.8%.

In short, the PDIVs of electret samples (i.e., test coupons with charged SiO₂/Si₃N₄ thin film) were greater than those of the non-electret samples (i.e., test coupons with uncharged SiO₂/Si₃N₄ thin film). The results suggest that the high electric fields created by the high-voltage electrode were countered and reduced by the electric fields of the SiO₂/Si₃N₄ thin film electrets. Accordingly, higher voltage was required to reach electric fields large enough to cause PD.

### 3. Conclusions

For the first time, it has been demonstrated that thin film electrets can mitigate PD caused by steep voltage pulses at high temperatures. Test coupons were subjected without and with the SiO₂/Si₃N₄ thin film electret to steep square voltage pulses with slew rates as high as 75 V/ns at 25° C., 175° C., and 245° C. The results of PD measured at high temperatures demonstrated a substantial reduction in PD magnitude and an increase in PDIV in test coupons incorporated with the SiO₂/Si₃N₄ thin film electrets. In short, the thin film electrets fabricated in this study reduced PD magnitude by as much as 95% and increased PDIV by as much as 13.8%. The results of this work create new pathways for developing WBG and UWBG power modules that can operate in harsh electrical and thermal conditions without PD.

### B. Parylene Electret

### 1. Reduced PD at High Temperatures

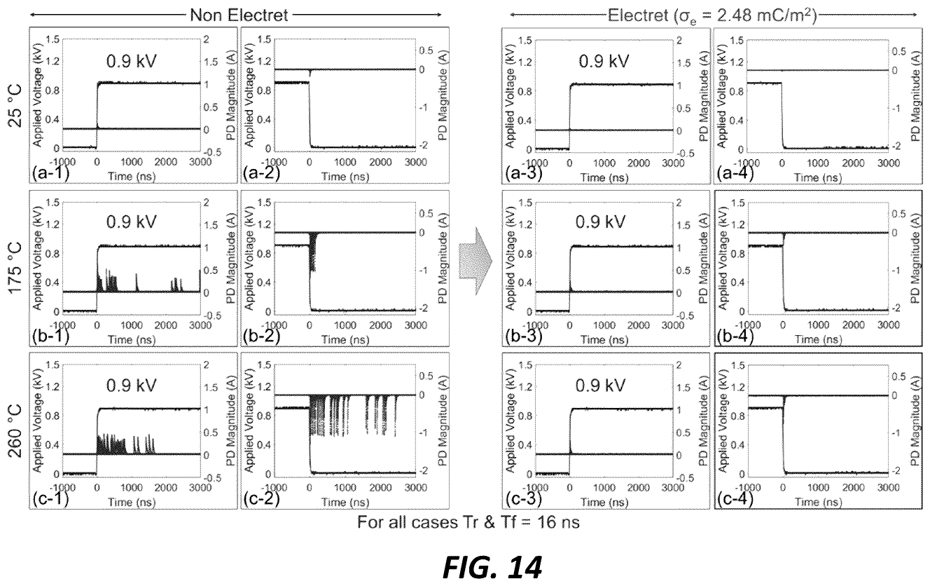

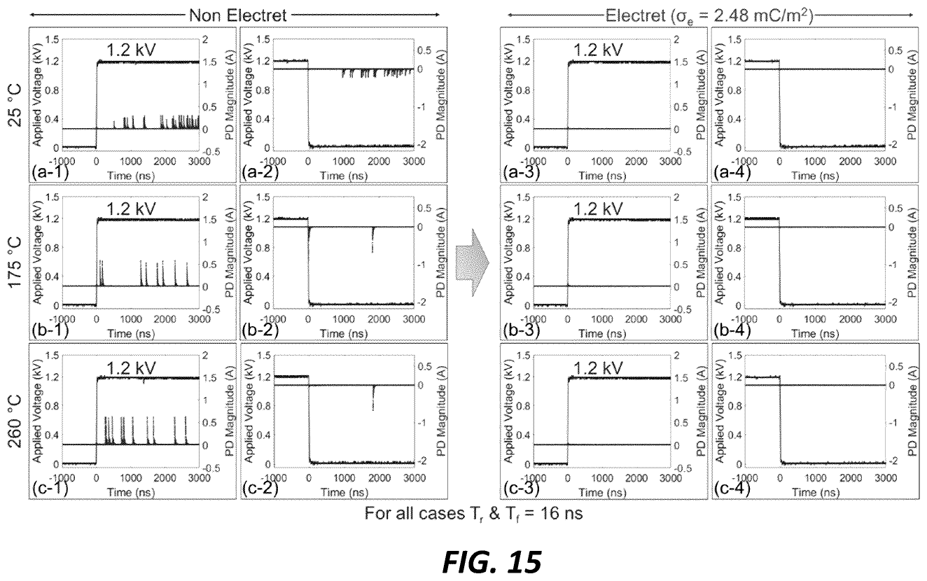

PD was measured under steep square voltage pulses at 25° C., 175° C., and 260° C. for the following two cases: i) Parylene and ii) Kapton on Parylene. 1) Parylene: The PD measurement results using only the Parylene thin film placed between the high and ground electrodes are shown in FIG. 14. The non-electret and electret in FIG. 14 refer to the uncharged and charged Parylene thin films, respectively. 0.9 kV was applied across non-electret and electret thin films at 25° C., 175° C., and 260° C. The figure shows that 0.9 kV is below the PDIV of the non-electret sample at 25° C., but above the PDIV of the non-electret sample at 175° C. and 260° C. The rising and falling time of the square voltage pulse was 16 ns, which translates to the slew rate of 56.25 V/ns. PD measured from non-electret and electret test coupons at 25° C. are shown in FIG. 15(a-1) through (a-4). The maximum PD magnitudes measured from the non-electret sample at the rising and falling edges are 0.13 A and −0.19 A, respectively, as shown in FIGS. 14(a-1) and (a-2). On the other hand, the maximum PD magnitudes measured from the electret sample at the rising and falling edges are 0.041 A and −0.02 A, respectively, as shown in FIGS. 14(a-3) and (a-4). These results suggest that the Parylene thin film electrets reduced PD at the rising and falling edges by 68% and 89%, respectively, at 25° C. In addition, PD measured from non-electret and electret test coupons at 175° C. are shown in FIG. 14(b-1) through (b-4). The maximum PD magnitudes measured from the non-electret sample at the rising and falling edges are 0.63 A and −1.225 A, respectively, as shown in FIGS. 14(b-1) and (b-2).

On the other hand, the maximum PD magnitudes measured from the electret sample at the rising and falling edges are 0.26 A and −0.25 A, respectively, as shown in FIGS. 14(b-3) and (b-4). These results suggest that the Parylene thin film electrets reduced PD at the rising and falling edges by 59% and 80%, respectively, at 175° C. Furthermore, PD measured from non-electret and electret test coupons at 260° C. are shown in FIG. 14(c-1) through (c-4). The maximum PD magnitudes measured from the non-electret sample at the rising and falling edges are 0.56 A and −1.32 A, respectively, as shown in FIGS. 14(c-1) and (c-2). Whereas the maximum PD magnitudes measured from the electret sample at the rising and falling edges are 0.31 A and −0.34 A, respectively, as shown in FIGS. 14(c-3) and (c-4). These results suggest that the Parylene thin film electrets reduced PD at the rising and falling edges by 45% and 74%, respectively, at 260° C.

2) Kapton on Parylene: The PD measurement results using Kapton film placed on top of the Parylene thin film are shown in FIG. 15. The non-electret and electret in FIG. 15 refer to the uncharged and charged Parylene thin films, respectively. 1.2 kV was applied across non-electret and electret thin films at 25° C., 175° C., and 260° C. The figure shows that 1.2 kV is above the PDIV of the non-electret test coupons but below the PDIV of the electret test coupons at all three temperatures. The rising and falling time of the square voltage pulse was 16 ns, which translates to the slew rate of 75 V/ns. PD measured from non-electret and electret test coupons at 25° C. are shown in FIG. 15(a-1) through (a-4). The maximum PD magnitudes measured from the non-electret test coupon at the rising and falling edges are 0.30 A and −0.23 A, respectively, as shown in FIGS. 15(a-1) and (a-2). On the other hand, the maximum PD magnitudes measured from the electret test coupon at the rising and falling edges are 0.041 A and −0.026 A, respectively, as shown in FIGS. 15(a-3) and (a-4). These results suggest that the Parylene thin film electrets reduced PD at the rising and falling edges by 86% and 89%, respectively, at 25° C.

### 2. Increased PDIV at High Temperatures

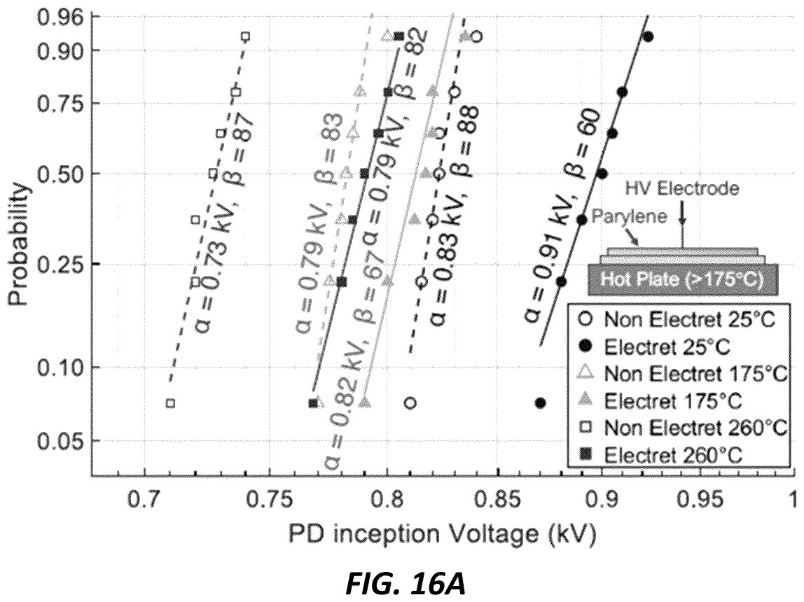

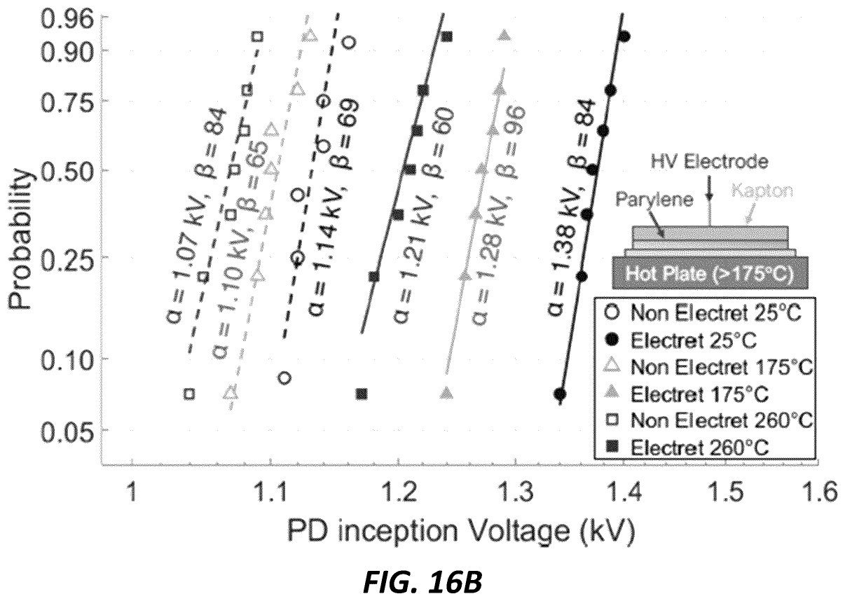

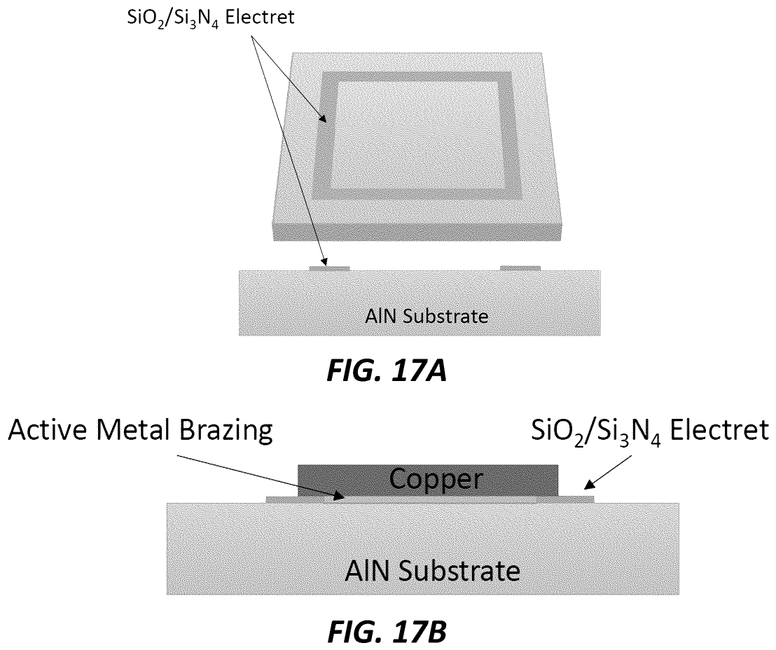

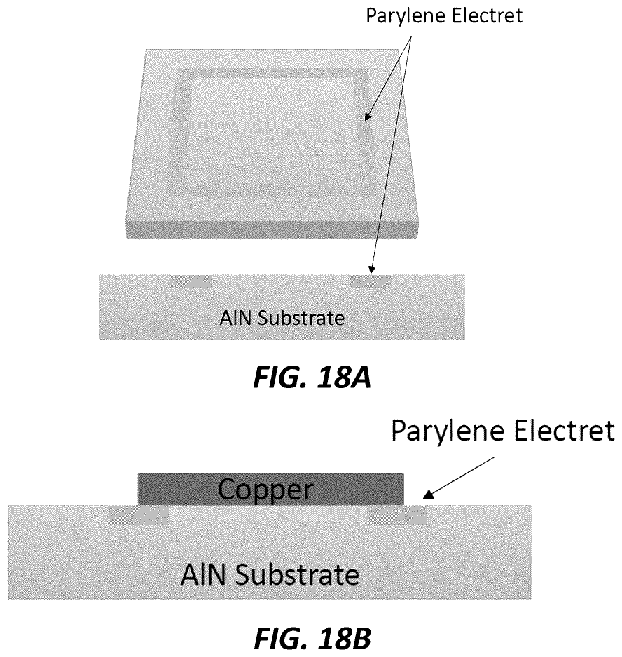

The PDIV of the non-electret and electret test coupons at 25° C., 175° C., and 260° C. were measured and compared. Two cases were investigated: i) PDIV of the Parylene thin film alone and ii) that of Kapton film placed on top of the Parylene thin film. In all cases, the amplitude of the square voltage pulses was gradually raised until PD occurred. The PDIV measurement underwent seven times to form the Weibull distributions shown in FIGS. 16A-16B. The two-parameter Weibull function is defined as

$$P ( {U}_{i} ) = 1 - exp [ - {( \frac{{U}_{i}}{α} )}^{β} ] \qquad ( 6 )$$

where P is the cumulative failure probability and Uᵢ is the measured breakdown voltage. The 63.2% cumulative probability of PDIV is denoted by the scale parameter α. The shape parameter β denotes the distribution width, where a smaller β value indicates a greater scatter in a dataset. Equation (6) can be rewritten as follows

$$log \{ - ln [ 1 - P ( {U}_{i} ) ] \} = β log ( {U}_{i} ) - β log ( α ) \qquad ( 7 )$$

Based on the equation above, the scale parameter α and shape parameter β are obtained through the linear regression of log{−ln[1−P(Uᵢ)]} vs. log(Uᵢ). The scale parameter α is used to represent the PDIV of respective experiments. At 25° C., the α and β values for the non-electret samples were 0.83 kV and 88, respectively, and those for the electret samples were 0.91 kV and 60, respectively. The α values indicate that the Parylene thin film electret increased PDIV by 9.6% at 25° C. Similarly, at 175° C., the α and β values for the non-electret samples are 0.79 kV and 83, respectively, and those for the electret samples are 0.82 kV and 67, respectively. At 175° C., the Parylene thin film electret increased PDIV also by 3.8%. Furthermore, at 260° C., the α and β values for the non-electret samples are 0.73 kV and 87, respectively, and those of the electret samples are 0.79 kV and 82, respectively. At 260° C., the Parylene thin film electret increased PDIV by 8.2%.

2) Kapton on Parylene: At 25° C., the α and β values for the non-electret samples are 1.14 kV and 60, respectively, and those for the electret samples are 1.38 kV and 84, respectively. The α values indicate that the Parylene thin film electret increased PDIV by 21% at 25° C. Similarly, at 175° C., the α and β values for the non-electret samples are 1.10 kV and 65, respectively, and those for the electret samples are 1.28 kV and 96, respectively. At 175° C., the Parylene thin film electret increased PDIV also by 16.4%. Furthermore, at 260° C., the α and β values for the non-electret samples are 1.07 kV and 84, respectively, and those of the electret samples are 1.21 kV and 60, respectively. At 260° C., the Parylene thin film electret increased PDIV by 13.08%. In short, the PDIVs of electret samples (i.e., test coupons with charged Parylene thin film) are greater than those of the non-electret samples (i.e., test coupons with uncharged Parylene thin film). The findings imply that the electric fields of the Parylene thin film electrets have reduced the electric fields produced by the high-voltage electrode. Consequently, higher voltage was necessary to reach electric fields strong enough to initiate PD. While the current findings show promise, more research is required to further increase PDIV.

### 3. Conclusions

For the first time, it has been demonstrated that Parylene thin film electrets can mitigate PD caused by steep square voltage pulses at high temperatures. The test coupons without and with the Parylene thin film electret were subjected to steep square voltage pulses with slew rates as high as 75 V/ns at 25° C., 175° C., and 260° C. In both test coupon arrangements (i.e., Parylene and Kapton on Parylene), the results of PD measurements at high temperatures showed a significant decrease in PD magnitude and an increase in PDIV in test coupons using the Parylene thin film electrets. In short, the Parylene thin film electrets proposed and fabricated in this study reduced PD magnitude by as much as 96% and increased PDIV by as much as 21%. The outcomes of this research open new avenues for creating WBG and UWBG power modules that are PD-free and capable of functioning in harsh electrical and thermal environments.

For reasons of completeness, the following clauses are provided:

Clause 1. An electrical component comprising:
a top conductive layer;
a dielectric layer;
a bottom conductive layer;
an encapsulating material; and
an electret interposed between a surface of the top conductive layer and a surface of the dielectric layer, the electret comprising:
   a silicon nitride (Si₃N₄) layer supported by a silicon dioxide (SiO₂) layer; or a Parylene layer;
wherein the top conductive layer, the electret, and the encapsulating material intersect at a triple point (Tₚ).
   Clause 2. The electrical component according to clause 1, wherein the top conductive layer, the dielectric layer, and the bottom conductive layer are arranged in a stacked configuration.
   Clause 3. The electrical component according to clause 2, wherein the encapsulating material contacts and surrounds the stacked configuration.
   Clause 4. The electrical component according to any one of clauses 1-3, wherein the electret comprises the silicon nitride (Si₃N₄) layer supported by the silicon dioxide (SiO₂) layer.
   Clause 5. The electrical component according to any one of clauses 1-4, wherein the silicon nitride (Si₃N₄) layer has a thickness of 0.1 nm to 1 mm.
   Clause 6. The electrical component according to any one of clauses 1-5, wherein the silicon dioxide (SiO₂) layer has a thickness of 0.1 nm to 1 mm.
   Clause 7. The electrical component according to any one of clauses 1-3, wherein the electret comprises the Parylene layer.
   Clause 8. The electrical component according to any one of clauses 1-3 or 7, wherein the Parylene layer has a thickness of 0.1 nm to 1 mm.
   Clause 9. The electrical component according to any one of clauses 1-8, wherein the electret has a surface charge density of 0.1 mC/m² to 30 mC/m².
   Clause 10. The electrical component according to any one of clauses 1-9, wherein an electric field at the triple point is less than 100 V.
   Clause 11. A power substrate comprising the electrical component according to any one of clauses 1-10.
   Clause 12. A power electronic module comprising the electrical component according to any one of clauses 1-10.
   Clause 13. A laminated busbar comprising the electrical component according to any one of clauses 1-10.
   Clause 14. A method of manufacturing an electret, the method comprising:
providing a substrate;
depositing a thin film onto the substrate, the thin film comprising:
   a silicon nitride (Si₃N₄) layer supported by a silicon dioxide (SiO₂) layer; or
   a Parylene layer; and
triode corona charging the thin film.
   Clause 15. The method according to clause 14, wherein the thin film is deposited onto the substrate via sputtering and electron beam evaporation.
   Clause 16. The method according to clause 14 or 15, wherein the thin film comprises the silicon nitride (Si₃N₄) layer supported by the silicon dioxide (SiO₂) layer.
   Clause 17. The method according to any one of clauses 14-16, wherein the silicon nitride (Si₃N₄) layer has a thickness of 0.1 nm to 1 mm.
   Clause 18. The method according to any one of clauses 14-17, wherein the silicon dioxide (SiO₂) layer has a thickness of 0.1 nm to 1 mm.
   Clause 19. The method according to clause 14 or 15, wherein the thin film comprises the Parylene layer.
   Clause 20. The method according to clause 19, wherein the Parylene layer has a thickness of 0.1 nm to 1 mm.

1. An electrical component comprising:
a top conductive layer;
a dielectric layer;
a bottom conductive layer;
an encapsulating material; and
an electret interposed between a surface of the top conductive layer and a surface of the dielectric layer, the electret comprising:
a silicon nitride (Si₃N₄) layer supported by a silicon dioxide (SiO₂) layer; or
a Parylene layer;
wherein the top conductive layer, the electret, and the encapsulating material intersect at a triple point (Tₚ).

2. The electrical component according to claim 1, wherein the top conductive layer, the dielectric layer, and the bottom conductive layer are arranged in a stacked configuration.

3. The electrical component according to claim 2, wherein the encapsulating material contacts and surrounds the stacked configuration.

4. The electrical component according to claim 1, wherein the electret comprises the silicon nitride (Si₃N₄) layer supported by the silicon dioxide (SiO₂) layer.

5. The electrical component according to claim 4, wherein the silicon nitride (Si₃N₄) layer has a thickness of 0.1 nm to 1 mm.

6. The electrical component according to claim 4, wherein the silicon dioxide (SiO₂) layer has a thickness of 0.1 nm to 1 mm.

7. The electrical component according to claim 1, wherein the electret comprises the Parylene layer.

8. The electrical component according to claim 7, wherein the Parylene layer has a thickness of 0.1 nm to 1 mm.

9. The electrical component according to claim 1, wherein the electret has a surface charge density of 0.1 mC/m² to 30 mC/m².

10. The electrical component according to claim 1, wherein an electric field at the triple point is less than 100 V.

11. A power substrate comprising the electrical component according to claim 1.

12. A power electronic module comprising the electrical component according to claim 11.

13. A laminated busbar comprising the electrical component according to claim 1.

14. A method of manufacturing an electret, the method comprising:
providing a substrate;
depositing a thin film onto the substrate, the thin film comprising:
a silicon nitride (Si₃N₄) layer supported by a silicon dioxide (SiO₂) layer; or
a Parylene layer; and
triode corona charging the thin film.

15. The method according to claim 14, wherein the thin film is deposited onto the substrate via sputtering and electron beam evaporation.

16. The method according to claim 14, wherein the thin film comprises the silicon nitride (Si₃N₄) layer supported by the silicon dioxide (SiO₂) layer.

17. The method according to claim 16, wherein the silicon nitride (Si₃N₄) layer has a thickness of 0.1 nm to 1 mm.

18. The method according to claim 16, wherein the silicon dioxide (SiO₂) layer has a thickness of 0.1 nm to 1 mm.

19. The method according to claim 14, wherein the thin film comprises the Parylene layer.

20. The method according to claim 19, wherein the Parylene layer has a thickness of 0.1 nm to 1 mm.
